(19) United States
(12) Patent Application Publication
(10) Pub. No.: US 2019/0164489 A1
(43) Pub. Date: May 30, 2019

(54) NOTCH CUTTING OLED DISPLAY PANEL AND OLED DISPLAY

(71) Applicant: Wuhan China Star Optoelectronics Semiconductor Display Technology Co., Ltd., Wuhan (CN)

(72) Inventors: Di ZHANG, Shenzhen (CN); Xiaoxia ZHANG, Shenzhen (CN)

(21) Appl. No.: 15/939,739

(22) Filed: Mar. 29, 2018

Related U.S. Application Data
(63) Continuation of application No. PCT/CN2018/071599, filed on Jan. 5, 2018.

(30) Foreign Application Priority Data
Nov. 30, 2017 (CN) 201711239560.2

(51) Int. Cl. G09G 3/3258; G09G 3/3266

(52) U.S. Cl. CPC G09G 3/3258; G09G 3/3266

(57) ABSTRACT

The present disclosure discloses a notch cutting OLED display panel, including: a normal display area having a plurality of first scan lines extending in the lateral direction; a notch area having a missing hole, and a first display area and a second display area located on two sides of the missing hole, the first display area having second scan lines extending in the lateral direction, and the second display area having third scan lines extending in the lateral direction; a first gate driver and a second gate driver. At least one of the first gate driver and the second gate driver drives the first scan lines in the normal display area, at least one of the first gate driver and the second gate driver drives the second scan lines and the third scan lines. The present disclosure further discloses an OLED display.

### RELATED APPLICATIONS

This application is a continuation application of PCT Patent Application No. PCT/CN2018/071599, filed Jan. 5, 2018, which claims the priority benefit of Chinese Patent Application No. CN 201711239560.2, filed Nov. 30, 2017, which is herein incorporated by reference in its entirety.

### FIELD OF THE DISCLOSURE

The present disclosure relates to a display technology field, and more particularly to a notch cutting OLED display panel and an OLED display.

### BACKGROUND OF THE DISCLOSURE

Organic Light-Emitting Diode (OLED) display panels are favored due to their thinness, energy saving, wide viewing angle, wide color gamut and high contrast ratio. With the development of OLED display panel, OLED flexible display technology has been an important development, flexible OLED display can be notch cutting, which can achieve the terminal display with a high screen share. However, it is an urgent problem to be solved how to drive scan lines on the inside of an OLED display panel with a special shape after the flexible OLED display has been shaped.

### SUMMARY OF THE DISCLOSURE

The technical problem to be solved in the embodiments of the present disclosure is to provide a notch cutting OLED display panel and an OLED display. Which can effectively realize the scanning of the scan lines in the notch cutting OLED display panel.

In order to solve the above technical problem, an embodiment of the first aspect of the present disclosure provides a notch cutting OLED display panel, including:

a normal display area having a plurality of first scan lines extending in the lateral direction;
a notch area having a missing hole, and a first display area and a second display area located on two sides of the missing hole, the first display area having second scan lines extending in the lateral direction, and the second display area having third scan lines extending in the lateral direction;
a first gate driver and a second gate driver, extending from two sides of the normal display area to two sides of the notch area, at least one of the first gate driver and the second gate driver driving the first scan lines in the normal display area, and at least one of the first gate driver and the second gate driver driving the second scan lines and the third scan lines.

Wherein the first gate driver drives the second scan lines adjacent thereto; and the second gate driver drives the third scan lines adjacent thereto.

Wherein the number of the second scan lines is equal to the number of the third scan lines, the second scan lines are electrically connected to the third scan lines in a one-to-one correspondence, at least one of the first gate driver and the second gate driver is configured to drive the second scan lines and the third scan lines.

Wherein the notch area further includes a trace area, the trace area is inverted n-type, the trace area partially encloses the missing hole toward the side close to the normal display area, a connecting scan lines is disposed in the trace area, and the second scan lines is connected to the third scan lines via the connecting scan lines.

Wherein the notch area further includes a trace area, the trace area is n-shaped, the trace area partially encloses the missing hole toward the side away from the normal display area, a connecting scan lines is disposed in the trace area, and the second scan lines is connected to the third scan lines via the connecting scan lines.

Wherein the trace area is folded back to reduce the area of the non-display area in the notch area.

Wherein the OLED display panel further includes a third gate driver and a fourth gate driver, the first gate driver and the third gate driver are located on two sides of the first display area configured to drive the second scan lines, the second gate driver and the fourth gate driver are located on two sides of the second display area and configured to drive the third scan lines.

Wherein the OLED display panel further includes a timing controller that generates a clock signal and a turn-on signal, the first gate driver and the second gate driver respectively receive the clock signal and the turn-on signal, the third gate driver and the fourth gate driver respectively receive the clock signal, and the third gate driver and the fourth gate driver respectively receive the turn-on signal or the signal transmitted from the first scan lines closest to the notch area in the normal display area.

Wherein the missing hole is a closed hole or an open with one side opened.

An embodiment of the second aspect of the present disclosure provides an OLED display, including the above-mentioned notch cutting OLED display panel.

The implementation of the embodiments of the present disclosure has the following beneficial effects.

Since the notch area is provided with a missing hole and a first display area located on two sides of the missing hole, the second display area can be used for installing other necessary components, a second scan lines extending in the lateral direction is provided in the first display area, a third scan lines extending in the lateral direction is provided in the second display area, at least one of the first gate driver and the second gate driver drives the second scan lines and the third scan lines. Therefore, the second scan lines and the third scan lines located in the notch area can be stably driven, and further, the notch area can be used for displaying, thereby improving the screen occupancy ratio.

### BRIEF DESCRIPTION OF THE DRAWINGS

To describe the technical solutions in the embodiments of the present disclosure or in the prior art more clearly, the following briefly introduces the accompanying drawings required for describing the embodiments or the prior art. Apparently, the accompanying drawings in the following description show merely some embodiments of the present disclosure, and a person of ordinary skill in the art may still derive other drawings from these accompanying drawings without creative efforts.

FIG. 1 is a schematic diagram of a notch cutting OLED display panel according to Embodiment 1 of the present disclosure.

FIG. 2 is a schematic diagram of a notch cutting OLED display panel according to Embodiment 2 of the present disclosure.

FIG. 3 is a schematic diagram of a notch cutting OLED display panel according to Embodiment 3 of the present disclosure.

FIG. 4 is a schematic diagram of a notch cutting OLED display panel according to Embodiment 4 of the present disclosure.

FIG. 5 is a schematic diagram of a notch cutting OLED display panel according to Embodiment 5 of the present disclosure.

### DETAILED DESCRIPTION OF PREFERRED EMBODIMENTS

The technical solutions in the embodiments of the present disclosure will be described clearly and completely hereinafter with reference to the accompanying drawings in the embodiments of the present disclosure. Apparently, the described embodiments are merely some but not all embodiments of the present disclosure. All other embodiments obtained by persons of ordinary skill in the art based on the embodiments of the present disclosure without creative efforts shall fall within the protection scope of the present disclosure.

The terms “including” and “having,” as well as any variations thereof, appearing in the specification, claims and drawings, are intended to cover the inclusion of non-exclusive. For example, a process, method, system, product, or device that incorporates a series of steps or units is not limited to the steps or units listed, but may optionally include steps or units not listed, or optionally further steps or units inherent to these processes, methods, products or devices. In addition, the terms “first”, “second” and “third” are used to distinguish different objects and are not intended to describe a specific order.

### Embodiment 1

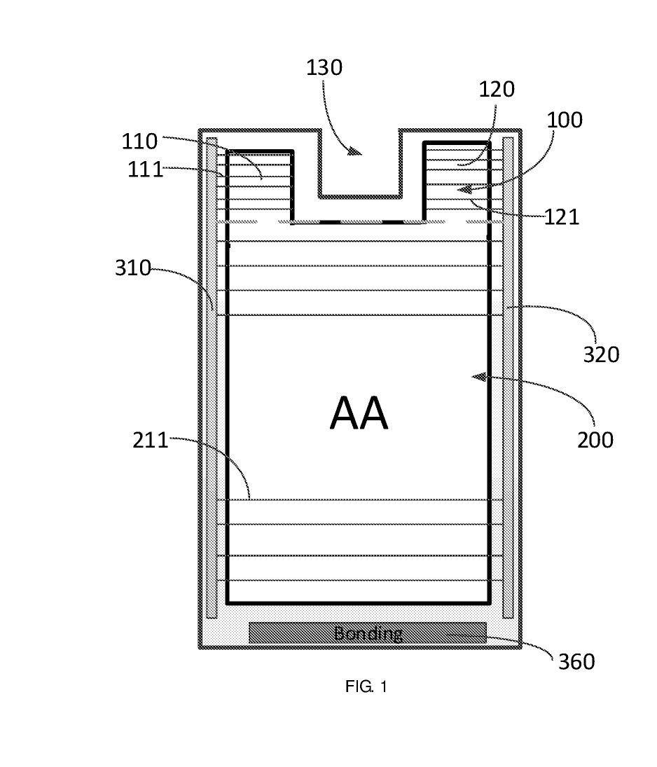

The embodiment of the present disclosure provides a notch cutting OLED display panel, referring to FIG. 1, the OLED display panel includes a normal display area 200, a notch area 100 (the normal display area and the notch area in FIG. 1 are separated by a dotted line), a first gate driver 310 and a second gate driver 320.

In this embodiment, the normal display area 200 refers to a regular shape in which display images, characters and the like can be displayed. The normal display area 200 is, for example, a regular shape such as a square or a rectangle. In order to achieve normal display, a plurality of first scan lines 211 extending in the lateral direction are disposed in the normal display area 200. The first scan lines 211 are electrically connected to the gates of the switch TFTs of the OLED display panel. In this embodiment, the normal display area 200 is further provided with a plurality of data lines (not shown in the figure) extending in the longitudinal direction, and the data lines extend from the normal display area 200 to the notch area 100.

In this embodiment, the notch area 100 refers to an irregular shape of the displayable screen, in the present embodiment, the notch area 100 is a concave shape, that is, an area where the notch area 100 is missing is a rectangle, the missing area of the notch area 100 may be used for arranging components such as a camera, a main control button, and a sound tube independent from the OLED display panel. Therefore, the entire lateral area of the main control button, the sound tube and the like can not be used for displaying relative to the prior art camera. The notch area 100 of the notch cutting OLED display panel of the embodiment of the present disclosure can also be displayed, improving the screen occupancy ratio.

Specifically, in this embodiment, the notch area 100 is provided with a missing hole 130 and a first display area 110 and a second display area 120 on two sides of the missing hole 130, the missing hole 130 is an area corresponding to the notch area 100. In the present embodiment, the missing hole 130 is an open side with one side open. In the present embodiment, the missing hole 130 is open at the upper side, for example, a “U” type, a semicircle, a “C” type, or the like. In the present embodiment, two the first display area 110 and the second display area 120 can be used for displaying images, characters, etc. The second display area 110 has second scan lines 111 extending in the lateral direction, the second display area 120 is provided with third scan lines 121 extending in the lateral direction.

In this embodiment, the first gate driver 310 is located on the left side of the normal display area 200 and the notch area 100 shown in FIG. 1, the second gate driver 320 is located on the right side of the normal display area 200 and the notch area 100 shown in FIG. 1, the first gate driver 310 extends from the left side of the normal display area 200 to the left side of the notch area 100, the second gate driver 320 extends from the right side of the normal display area 200 to the right side of the notch area 100. In this embodiment, two sides of all the first scan lines 211 in the normal display area 200 are respectively electrically connected to the first gate driver 310 and the second gate driver 320, the first gate driver 310 and the second gate driver 320 simultaneously drive the same first scan lines 211. Therefore, the driving manner of the first scan lines 211 in the normal display area 200 is a bilateral driving method well-known to those skilled in the art, such a scan line driving method can reduce the voltage drop caused by the impedance of the transmission line when the first scan lines 211 transmits signals. In addition, in other embodiments of the present disclosure, part of the first scan lines may be connected to the first gate driver, and another part of the first scan lines may be connected to the second gate driver, a first gate driver drives first scan lines electrically connected thereto, a second gate driver drives first scan lines electrically connected thereto. Therefore, the driving manner of the first scan lines in the normal display area is a unilateral driving method well-known to those skilled in the art. In addition, in other embodiments of the present disclosure, an odd number of first scan lines are connected to one of the first gate driver and the second gate driver, an even number of first scan lines are connected to the other of the first gate driver and the second gate driver, so that the first gate driver drives first scan lines electrically connected thereto, the second gate driver drives first scan lines electrically connected thereto. Therefore, the driving manner of the first scan lines in the normal display area is a staggered driving manner well-known to those skilled in the art.

In this embodiment, the second scan lines 111 is electrically connected to an adjacent gate driver. In this embodiment, the second scan lines 111 is electrically connected to the left first gate driver 310, the third scan lines 121 is electrically connected to an adjacent gate driver. In this embodiment, the third scan lines 121 is electrically connected to the second gate driver 320 on the right side, that is, the driving manner of the second scan lines 111 and the third scan lines 121 is a one-side driving manner well-known to those skilled in the art. In this embodiment, each of the first gate drivers 310 is electrically connected to the first scan lines 211 and the second scan lines 111, and each of the second gate drivers 320 is electrically connected to the first scan lines 211 and the third scan lines 121. However, the present disclosure is not limited thereto. In other embodiments of the present disclosure, one of the first gate driver and the second gate driver may be electrically connected to the first scan lines, the first gate driver and the second gate driver are used for driving the second scan lines and the third scan lines.

In this embodiment, the OLED display panel includes a bonding area 360 on a lower side thereof, and the OLED display panel further includes a flexible circuit board bound to the bonding area 360, a timing controller (Tcon) is disposed on the flexible circuit board, and the timing controller transmits a timing signal to the first gate driver 310 and the second gate driver 320. In this embodiment, the timing signal includes a clock signal (CK, XCK), an enable signal (STV), and the like.

Since the notch area 100 is provided with the missing hole 130 and the first display area 110 and the second display area 120 located on two sides of the missing hole 130, the first display area 110 is provided with second scan lines 111 extending in a lateral direction, and the second display area 120 is provided with third scan lines 121 extending in a lateral direction. At least one of the first gate driver 310 and the second gate driver 320 drives the second scan lines 111 and the third scan lines 121. Therefore, the second scan lines 111 and the third scan lines 121 located in the notch area 100 can be driven steadily. In addition, the notch area 100 can also be used for display, thereby improving the screen occupancy ratio.

### Embodiment 2

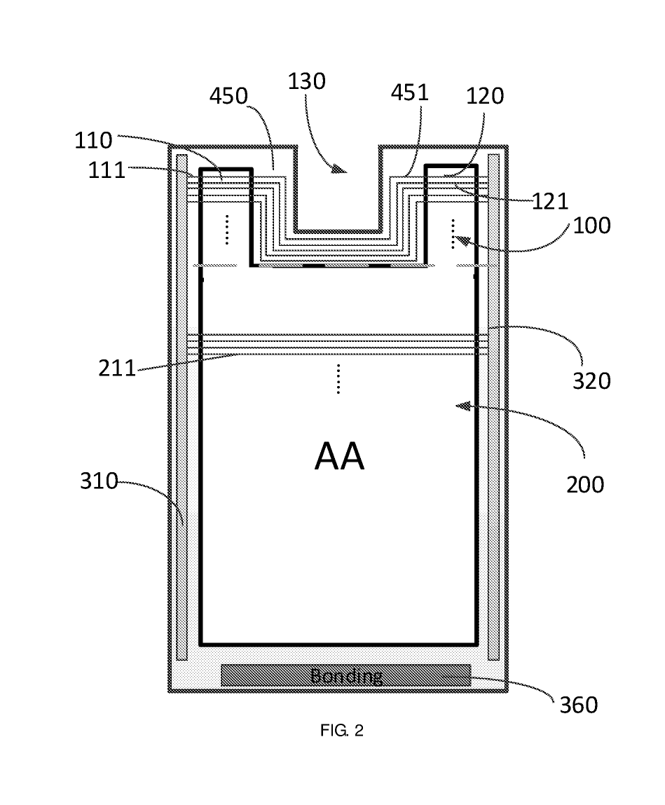

FIG. 2 is a schematic diagram of a notch cutting OLED display panel according to Embodiment 2 of the present disclosure. The schematic diagram of FIG. 2 is similar to the schematic diagram of FIG. 1, and therefore the same reference numerals denote the same components. The main difference between this embodiment and the first embodiment is the connection between the second scan lines and the third scan lines.

Referring to FIG. 2, in the present embodiment, the second scan lines 111 and the third scan lines 121 are not separated, and both are electrically connected. Specifically, in this embodiment, the number of the second scan lines 111 is the same as the number of the third scan lines 121, the second scan lines 111 are electrically connected to the third scan lines 121 in a one-to-one correspondence, that is, one second scan lines 111 and one third scan line 121 are electrically connected to one scan line. Thus, the signal on the second scan lines 111 may be directly transmitted to the third scan lines 121, or the signal on the third scan lines 121 may be directly transmitted to the second scan lines 111. In this embodiment, the left side of the second scan lines 111 is electrically connected to the first gate driver 310 and the right side of the third scan lines 121 is electrically connected to the second gate driver 320, the right side of the second scan lines 111 is electrically connected to the left side of the third scan lines 121 in a one-to-one correspondence. In this embodiment, the driving manner of the second scan lines 111 and the third scan lines 121 may be bilateral driving, unilateral driving, cross driving, or the like.

In this embodiment, in order to achieve the electrical connection between the second scan lines 111 and the third scan lines 121, in the present embodiment, the notch area 100 further includes a trace area 450, the alignment area 450 is inverted n-type, and the alignment area 450 partially surrounds the missing hole 130 toward a side close to the normal display area 200. Specifically, the alignment area 450 includes a first vertical portion, a lateral portion, and a second vertical portion. Two sides of the lateral portion respectively connect the bottom sides of the first vertical portion and the second vertical portion. The first vertical portion is located between the missing hole 130 and the first display area 110, the second vertical portion is located between the missing hole 130 and the second display area 120, the lateral portion is located between the missing hole 130 and the normal display area 200. In this embodiment, the connecting scan lines 451 are provided in the alignment area 450. The number of the connecting scan lines 451 is equal to the number of the second scan lines 111 and the third scan lines 121, the connecting scan lines 451 is configured to connect the right side of the second scan lines 111 and the left side of the third scan lines 121 to achieve a one-to-one electrical connection between the second scan lines 111 and the third scan lines 121. In this embodiment, the material of the connecting scan lines 451 may be the same as that of the second scan lines 111 and the third scan lines 121. In this embodiment, since the second scan lines 111 and the third scan lines 121 are electrically connected, the scan lines of the notch area 100 can be driven in various manners, and the voltage drop on the scan lines can be reduced.

### Embodiment 3

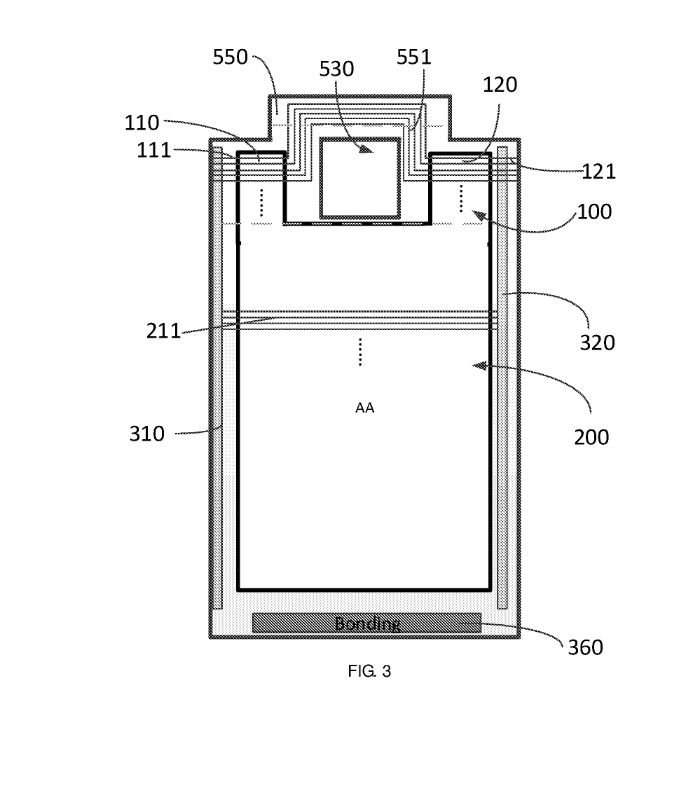

FIG. 3 is a schematic diagram of a notch cutting OLED display panel according to Embodiment 3 of the present disclosure. The schematic diagram of FIG. 3 is similar to the schematic diagram of FIG. 1, and therefore the same reference numerals denote the same components. The main difference between this embodiment and the first embodiment is the connection between the second scan lines and the third scan lines.

Referring to FIG. 3, in the present embodiment, the second scan lines 111 and the third scan lines 121 are not separated, and both are electrically connected. Specifically, in this embodiment, the number of the second scan lines 111 is the same as the number of the third scan lines 121, the second scan lines 111 and the third scan lines 121 are electrically connected in a one-to-one correspondence, that is, one second scan lines 111 and one third scan lines 121 are electrically connected to one scan line. Thus, the signal on the second scan lines 111 may be directly transmitted to the third scan lines 121, or the signal on the third scan lines 121 may be directly transmitted to the second scan lines 111. In this embodiment, the left side of the second scan lines 111 is electrically connected to the first gate driver 310, the right side of the third scan lines 121 is electrically connected to the second gate driver 320, the right side of the second scan lines 111 is electrically connected to the left side of the third scan lines 121 in a one-to-one correspondence. In this embodiment, the driving manner of the second scan lines 111 and the third scan lines 121 may be bilateral driving, unilateral driving, cross driving, or the like.

In this embodiment, in order to achieve the electrical connection between the second scan lines 111 and the third scan lines 121, in the present embodiment, the notch area 100 further includes a trace area 550 having an n-type shape. The trace area 550 surrounds the missing hole 130 at a side far away from the normal display area 200. Therefore, in this embodiment, the missing hole 530 is a closed hole, that is, the periphery of the missing hole 530 is closed. The missing hole 530 is, for example, a rectangular hole, a circular hole, a triangular hole, a hexagonal hole, an octagonal hole or the like. Specifically, in this embodiment, the alignment area 550 includes a first vertical portion, a lateral portion, and a second vertical portion. Two sides of the lateral portion respectively connect the top sides of the first vertical portion and the second vertical portion. The first vertical portion is located between the missing hole 130 and the first display area 110, the second vertical portion is located between the missing hole 130 and the second display area 120, and the lateral portion is located above the missing hole 130. In this embodiment, the connecting scan lines 551 is provided in the alignment area 550. The number of the connecting scan lines 551 is equal to the number of the second scan lines 111 and the third scan lines 121, the connecting scan lines 551 is for connecting the right side of the second scan lines 111, the left side of the third scan lines 121, so as to achieve a one-to-one electrical connection between the second scan lines 111 and the third scan lines 121. In this embodiment, the material of the connecting scan lines 551 may be the same as that of the second scan lines 111 and the third scan lines 121.

In this embodiment, since the entire OLED display panel may be flexible, the convex portion of the alignment area 550 is folded backwards (the broken line in FIG. 3 is a folding line). After being folded, the area of the area where the notch area 100 can not be displayed can be reduced. Therefore, compared with the second embodiment, since the lateral portion is not located between the missing hole 130 and the normal display area 200, the area of the normal display area 200 can be increased, so that the proportion of the screen can be increased.

### Embodiment 4

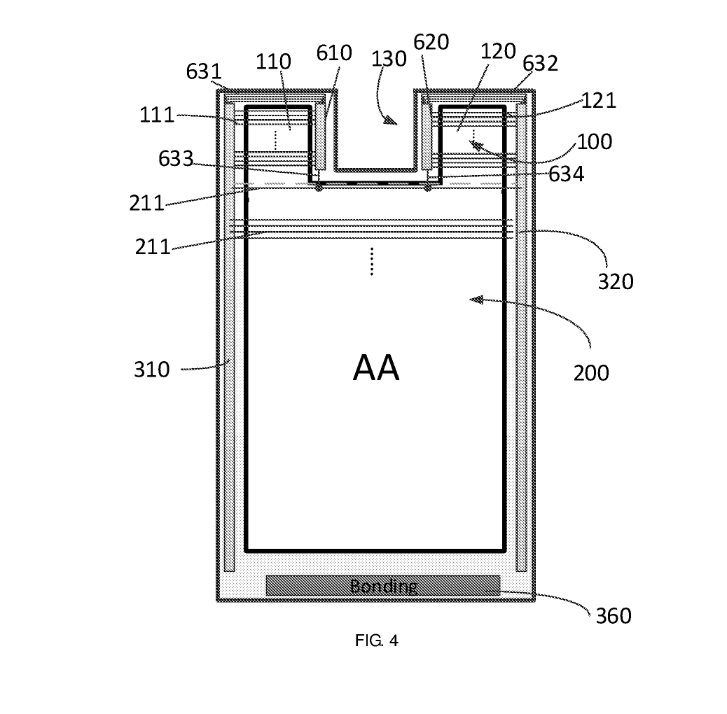

FIG. 4 is a schematic diagram of a notch cutting OLED display panel according to Embodiment 4 of the present disclosure. The schematic diagram of FIG. 4 is similar to the schematic diagram of FIG. 1, and therefore the same reference numerals denote the same components. The main difference between this embodiment and the first embodiment is a gate driver.

In this embodiment, the OLED display panel further includes a third gate driver 610 and a fourth gate driver 620. The first gate driver 310 and the third gate driver 610 are located at two sides of the first display area 110. Specifically, the first gate driver 310 is located on the left side of the first display area 110, the third gate driver 610 is located on the right side of the first display area 110, the second gate driver 320 and the fourth gate driver 620 are located at two sides of the second display area 120. Specifically, the second gate driver 320 is located at the right side of the second display area 120 and the fourth gate driver 620 is located at the left side of the second display area 120. In this embodiment, the first gate driver 310 and the third gate driver 610 drive the second scan lines 111, the second gate driver 320 and the fourth gate driver 620 drive the third scan lines 121.

Specifically, in the present embodiment, two sides of the third scan lines 121 are electrically connected to the first gate driver 310 and the third gate driver 610 respectively, two sides of the fourth scan lines are electrically connected to two sides of the second gate driver 320 and the fourth gate driver 620 respectively. Therefore, in this embodiment, the same second scan lines 111 is electrically connected to the first gate driver 310 and the third gate driver 610 at the same time, the same third scan lines 121 is electrically connected to the second gate driver 320 and the fourth gate driver 620 at the same time, that is, the driving manner of the second scan lines 111 is a double-side driving manner and the driving manner of the third scan lines 121 is also a two-side driving manner. Therefore, the second scan lines 111 and the third scan lines 121 have better signal transmission performance. In addition, in other embodiments of the present disclosure, the driving modes of the second scan lines and the third scan lines may be single-side driving, cross-driving, or the like.

In order to realize that the first gate driver 310, the second gate driver 320, the third gate driver 610 and the fourth gate driver 620 are sequentially driven. In this embodiment, the OLED display panel further includes a timing controller. The timing controller is located on the flexible circuit board. The flexible circuit board is bound to the bonding area 360 of the OLED display panel. In this embodiment, the bonding area 360 is located at the lower side of the OLED display panel. In this embodiment, the timing controller generates a clock signal and an enable signal, the lower sides of the first gate driver 310 and the second gate driver 320 are electrically connected to the flexible circuit board so as to receive the clock signal and the turn-on signal. In this embodiment, the first scan lines 211 is turned on sequentially from bottom to top, that is, the first gate driver 310 and the second gate driver 320 sequentially transmit the high-level gate signal to the first scan lines 211 from bottom to top.

Since the third gate driver 610 and the fourth gate driver 620 are added separately, in order to realize that the third gate driver 610 cooperates with the first gate driver 310, the fourth gate driver 620 is mated with the second gate driver 320. In this embodiment, the top of the third gate driver 610 and the top of the first gate driver 310 are electrically connected through a first clock signal transmission line 631 to transmit a clock signal to the third gate driver 610. A top side of the fourth gate driver 620 and a top side of the second gate driver 320 are electrically connected through a second clock signal transmission line 632 to transmit a clock signal to the fourth gate driver 620. In this embodiment, the bottom side of the third gate driver 610 is electrically connected to the first scan lines 211 closest to the notch area 100 in the normal display area 200. Specifically, the bottom of the third gate driver 610 and the first scan lines 211 of the uppermost side are electrically connected through the first control signal transmission line 633 to receive signals on the first scan lines 211. Therefore, when the last scan lines of the normal display area 200 (the uppermost first scan lines 211) receives the high-level gate signal, the lower side of the third gate driver 610 also receives the high-level gate signal, in combination with the clock signal, the third gate driver 610 and the first gate driver 310 can drive the second scan lines 111 in synchronization. Similarly, in this embodiment, the bottom side of the fourth gate driver 620 is electrically connected to the first scan lines 211 closest to the notch area 100 in the normal display area 200. Specifically, the bottom of the fourth gate driver 620 is electrically connected to the first scan lines 211 of the uppermost side through a second control signal transmission line 634 to receive a signal on the first scan lines 211. Therefore, when the last scan lines of the normal display area 200 (the uppermost first scan lines 211) receives the high-level gate signal, the lower side of the fourth gate driver 620 also receives the high-level gate signal, in combination with the clock signal, the fourth gate driver 620 and the second gate driver 320 can drive the third scan lines 121 in synchronization. In addition, in other embodiments of the present disclosure, when the bonding area is located at the upper side of the profiled area, that is, the flexible circuit board is located above the notch area, that is, the timing controller is located above the notch area. In this case, the first gate driver and the second gate driver respectively drive the second scan lines, the third scan lines and the first scan lines sequentially from top to bottom. At this time, upper sides of the first gate driver, the second gate driver third gate driver and the fourth gate driver are directly electrically connected to the flexible circuit board, so that the first gate driver, the second gate driver third gate driver and the fourth gate driver directly receive the clock signal generated by the timing controller and turn on the signal.

### Embodiment 5

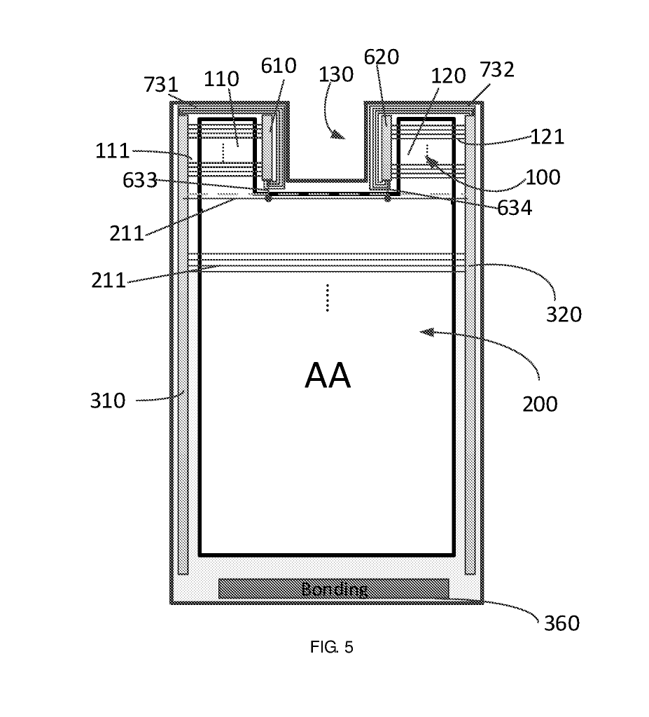

FIG. 5 is a schematic diagram of a notch cutting OLED display panel according to Embodiment 5 of the present disclosure. The schematic diagram of FIG. 5 is similar to the schematic diagram of FIG. 4, and therefore the same reference numbers refer to the same components. The main differences between this embodiment and the first embodiment are the input of the third gate driver and the fourth gate driver signal.

In this embodiment, the bonding area 360 is located at a lower side of the OLED display panel, that is, under the normal display area 200, so that a clock signal and an opening signal generated by the timing controller are uploaded from the lower side. In the present embodiment, the side (upper side) of the first gate driver 310 is electrically connected to the front side (lower side) of the third gate driver 610 through the first clock signal transmission line 731. Specifically, the first clock signal transmission line 731 is in a semi-enclosed structure, the first clock signal transmission line 731 passes over the side and the right side of the third gate driver 610 from the side of the first gate driver 310 to be connected to the front side (lower side) of the third gate driver 610, the first clock signal transmission line 731 is used for transmitting a clock signal. Similarly, the side (upper side) of the second gate driver 320 is electrically connected to the front side (lower side) of the fourth gate driver 620 through the second clock signal transmission line 732. Specifically, the second clock signal transmission line 732 has a semi-enclosed structure, the second clock signal transmission line 732 passes over the side and the left side of the fourth gate driver 620 from the side of the second gate driver 320 to be connected to the front side (lower side) of the fourth gate driver 620, the first clock signal transmission line 731 transmits a clock signal to the fourth gate driver 620.

In addition, an embodiment of the present disclosure further provides an OLED display, which includes the above-mentioned notch cutting OLED display panel.

It should be noted, each embodiment in the specification is described in a progressive manner. Each embodiment focuses on differences from other embodiments, and the same or similar parts in the embodiments may refer to each other. Since the apparatus embodiment is basically similar to the method embodiment, the description is relatively simple, and for the relevant part, reference may be made to the part of the method embodiment for illustration.

The above disclosure is only the preferred embodiments of the present disclosure, and certainly can not be used to limit the scope of the present disclosure. Therefore, equivalent changes made according to the claims of the present disclosure are still within the scope of the present disclosure.

What is claimed is:

1. A notch cutting OLED display panel, comprising:
a normal display area having a plurality of first scan lines extending in a lateral direction;
a notch area having a missing hole, and a first display area and a second display area located on two sides of the missing hole, the first display area having second scan lines extending in the lateral direction, and the second display area having third scan lines extending in the lateral direction;
a first gate driver and a second gate driver extending from two sides of the normal display area to two sides of the notch area, at least one of the first gate driver and the second gate driver driving the first scan lines in the normal display area, and at least one of the first gate driver and the second gate driver driving the second scan lines and the third scan lines.

2. The notch cutting OLED display panel according to claim 1, wherein the first gate driver drives the second scan lines adjacent thereto; and the second gate driver drives the third scan lines adjacent thereto.

3. The notch cutting OLED display panel according to claim 1, wherein a number of the second scan lines is equal to a number of the third scan lines, the second scan lines are electrically connected to the third scan lines in a one-to-one correspondence, at least one of the first gate driver and the second gate driver is configured to drive the second scan lines and the third scan lines.

4. The notch cutting OLED display panel according to claim 3, wherein the notch area further comprises a trace area, the trace area is an inverted n-type, the trace area partially encloses the missing hole toward a side close to the normal display area, connecting scan lines is disposed in the trace area, and the second scan lines is connected to the third scan lines via the connecting scan lines.

5. The notch cutting OLED display panel according to claim 3, wherein the notch area further comprises a trace area, the trace area is a n-shaped, the trace area partially encloses the missing hole toward a side away from the normal display area, connecting scan lines is disposed in the trace area, and the second scan lines is connected to the third scan lines via the connecting scan lines.

6. The notch cutting OLED display panel according to claim 5, wherein the trace area is folded back to reduce an area of a non-display area in the notch area.

7. The notch cutting OLED display panel according to claim 1, wherein the OLED display panel further comprises a third gate driver and a fourth gate driver, the first gate driver and the third gate driver are located on two sides of the first display area and configured to drive the second scan lines, the second gate driver and the fourth gate driver are located on two sides of the second display area and configured to drive the third scan lines.

8. The notch cutting OLED display panel according to claim 7, wherein the OLED display panel further comprises a timing controller that generates a clock signal and a turn-on signal, the first gate driver and the second gate driver respectively receive the clock signal and the turn-on signal, the third gate driver and the fourth gate driver respectively receive the clock signal, and the third gate driver and the fourth gate driver respectively receive the turn-on signal or a signal transmitted from the first scan lines closest to the notch area in the normal display area.

9. The notch cutting OLED display panel according to claim 1, wherein the missing hole is a closed hole or an open with one side opened.

10. The notch cutting OLED display panel according to claim 2, wherein the missing hole is a closed hole or an open with one side opened.

11. A OLED display, comprising a notch cutting OLED display panel, wherein the notch cutting OLED display panel comprises:
a normal display area having a plurality of first scan lines extending in a lateral direction;
a notch area having a missing hole, and a first display area and a second display area located on two sides of the missing hole, the first display area having second scan lines extending in the lateral direction, and the second display area having third scan lines extending in the lateral direction;
a first gate driver and a second gate driver, extending from two sides of the normal display area to two sides of the notch area, at least one of the first gate driver and the second gate driver driving the first scan lines in the normal display area, and at least one of the first gate driver and the second gate driver driving the second scan lines and the third scan lines.

12. The OLED display according to claim 11, wherein the first gate driver drives the second scan lines adjacent thereto; and the second gate driver drives the third scan lines adjacent thereto.

13. The OLED display according to claim 11, wherein a number of the second scan lines is equal to a number of the third scan lines, the second scan lines are electrically connected to the third scan lines in a one-to-one correspondence, at least one of the first gate driver and the second gate driver is configured to drive the second scan lines and the third scan lines.

14. The OLED display according to claim 13, wherein the notch area further comprises a trace area, the trace area is an inverted n-type, the trace area partially encloses the missing hole toward a side close to the normal display area, connecting scan lines is disposed in the trace area, and the second scan lines is connected to the third scan lines via the connecting scan lines.

15. The OLED display according to claim 13, wherein the notch area further comprises a trace area, the trace area is a n-shaped, the trace area partially encloses the missing hole toward a side away from the normal display area, connecting scan lines is disposed in the trace area, and the second scan lines is connected to the third scan lines via the connecting scan lines.

16. The OLED display according to claim 15, wherein the trace area is folded back to reduce an area of a non-display area in the notch area.

17. The OLED display according to claim 11, wherein the OLED display panel further comprises a third gate driver and a fourth gate driver, the first gate driver and the third gate driver are located on two sides of the first display area configured to drive the second scan lines, the second gate driver and the fourth gate driver are located on two sides of the second display area and configured to drive the third scan lines.

18. The OLED display according to claim 17, wherein the OLED display panel further comprises a timing controller that generates a clock signal and a turn-on signal, the first gate driver and the second gate driver respectively receive the clock signal and the turn-on signal, the third gate driver and the fourth gate driver respectively receive the clock signal, and the third gate driver and the fourth gate driver respectively receive the turn-on signal or a signal transmitted from the first scan lines closest to the notch area in the normal display area.

19. The OLED display according to claim 11, wherein the missing hole is a closed hole or an open with one side opened.

20. The OLED display according to claim 12, wherein the missing hole is a closed hole or an open with one side opened.
